(19) United States
(12) Patent Application Publication
(10) Pub. No.: US 2021/0081977 A1
(43) Pub. Date: Mar. 18, 2021

(54) Method and System for Crowdsourcing Home Value Estimate

(71) Applicant: Capital One Services, LLC, McLean, VA (US)

(72) Inventors: Michael Mossoba, Arlington, VA (US); Joshua Edwards, Philadelphia, PA (US); Abdelkader M'Hamed Benkreira, New York, NY (US)

(73) Assignee: Capital One Services, LLC, McLean, VA (US)

(21) Appl. No.: 16/568,718

(22) Filed: Sep. 12, 2019

(51) Int. Cl. G06Q 30/02; G06Q 50/16; G06F 3/0482; G06F 9/54; H04W 4/029

(52) U.S. Cl. CPC G06Q 30/0206; G06Q 30/0283; H04W 4/029; G06F 3/0482; G06F 9/542; G06Q 50/163

(57) ABSTRACT

A system and method for crowdsourcing a home value estimate is disclosed herein. Operations include receiving an initial home value estimate for a first home from one or more external computing systems, identifying a second home similar to the first home, and generating a graphical user interface. The operations further include prompting one or more users to select a preferred home between the at least one second home and the first home by transmitting a GUI to one or more client devices associated with the one or more users for display thereon, receiving an indication of a selection between the first home and the at least one second home, and modifying the initial home value estimate to a modified home value estimate based on the indication.

### FIELD OF THE DISCLOSURE

The present disclosure generally relates to a method and a system for crowdsourcing a home value estimate.

### BACKGROUND

Currently, the process of buying or renting a home is largely dependent on realtors, buyer's agents, and mortgage brokers. A potential home buyer or renter is limited in the ways he or she obtains information regarding the value of a particular home. Conventional systems typically rely on multiple service listings instead of buyer sentiment related to the home.

### SUMMARY

Embodiments disclosed herein generally related to a system and method for crowdsourcing a home value estimate. In one embodiment, a system for crowdsourcing a home value estimate is disclosed herein. The system includes a processor and a memory. The processor is in communication with at least one or more external data sources and one or more client devices. The memory has programming instructions stored thereon, which, when executed by the processor performs operations. The operations include receiving an initial home value estimate for a first home from one or more external computing systems. The operations include identifying a second home similar to the first home. The operations include generating a graphical user interface (GUI). The graphical user interface includes at least one or more images of the first home and at least one or more images of the second home. The operations include prompting one or more users to select a preferred home between the at least one second home and the first home by transmitting the graphical user interface to one or more client devices associated with the one or more users for display thereon. The operations include receiving an indication of a selection between the first home and the at least one second home. The operations include modifying the initial home value estimate to a modified home value estimate based on the indication.

In some embodiments, the operations of identifying a second home similar to the first home include identifying a second home having a home value estimate within a threshold range from the initial home value estimate of the first home.

In some embodiments, the operations of identifying a second home similar to the first home include identifying a second home having one or more characteristics within a threshold range from one or more characteristics of the first home.

In some embodiments, the one or more characteristics of each second home comprises a number of bedrooms, a number of bathrooms, square footage, neighborhood crime rate, asbestos, lead paint, types of appliances, outdoor space, parking availability, and type of heating, ventilation, and cooling system.

In some embodiments, the operations of generating the graphical user interface comprising the at least one or more images of the first home and the at least one or more images of the second home include generating a challenge-response test. The selection of either the first home or the second home signals to a web server that the user is human.

In another embodiment, a method of crowdsourcing a home value estimate is disclosed herein. A computing system generates a graphical user interface. The graphical user interface comprises a series of questions comparing one or more characteristics of one or more homes. The computing system prompts one or more users to select a characteristic by transmitting the graphical user interface to one or more client devices associated with the one or more users for display thereon. The computing system receives one or more responses from the one or more users. Each response is associated with a preference between at least two characteristics of the one or more homes. The computing system receives, from one or more external computing systems, an initial home value estimate for a first home of the one or more homes. The computing system identifies one or more first characteristics associated with the first home. The computing system determines that at least one response from the one or more users corresponds to at least one first characteristic of the one or more first characteristics. The computing system modifies the initial home value estimate to a modified home value estimate based on the at least one response.

In some embodiments, the one or more characteristics of each the one or more homes includes a number of bedrooms, a number of bathrooms, square footage, neighborhood crime rate, asbestos, lead paint, types of appliances, outdoor space, parking availability, and type of heating, ventilation, and cooling system.

In some embodiments, the series of questions are represented as a series of photographs, wherein each photograph in the series of photographs corresponds to a home of the one or more homes.

In some embodiments, generating, by the computing system, the graphical user interface comprising the series of questions comparing the one or more characteristics of the one or more homes includes the computing system generating a challenge-response test. Providing input to the graphical user interface in the form of responding to the series of questions signals to a web server that a user submitting the input is human.

In some embodiments, the computing system identifies a user profile corresponding to a received response. The computing system analyzes the user profile to identify one or more biases associated with the user profile. The computing system adjusts an impact of the received response on the initial home value estimate based on the identified one or more biases.

In some embodiments, the computing system identifies an internet protocol address from which a received response is transmitted. The computing system identifies, from the internet protocol address, a location of a user submitting the response. The computing system adjusts an impact of the received indication on the initial home value estimate based on the location of the user.

In some embodiments, the computing system generates an application programming interface linking functionality of the computing system to one or more third party financial institutions. The computing system provides access to the one or more third party financial institutions to one or more home value estimates.

In another embodiment, a method of crowdsourcing a home value estimate. A computing system receives an initial home value estimate for a first home from one or more external computing systems. The computing system identifies one or more second homes similar to the first home. The computing system generates a graphical user interface. The graphical user interface includes the first home and at least one second home. The computing system prompts one or more users to select a preferred home between the at least one second home and the first home by transmitting the GUI to one or more client devices associated with the one or more users for display thereon. The computing system receives, via the GUI, an indication of a selection between the first home and the at least one second home. The computing system modifies the initial home value estimate to a modified home value estimate based on the indication.

In some embodiments, identifying one or more second homes similar to the first home includes the computing system identifying one or more second homes having home value estimates within a threshold range from the initial home value estimate of the first home.

In some embodiments, identifying one or more second homes similar to the first home includes the computing system identifying one or more second homes having one or more characteristics within a threshold range from one or more characteristics of the first home.

In some embodiments, one or more characteristics of each second home includes a number of bedrooms, a number of bathrooms, square footage, neighborhood crime rate, asbestos, lead paint, types of appliances, outdoor space, parking availability, and type of heating, ventilation, and cooling system.

In some embodiments, generating a graphical user interface comprising the first home and at least one second home includes the computing system generating a challenge-response test. Selection of either the first home or the at least one second home signals to a web server that the user is human.

In some embodiments, the computing system identifies a user profile corresponding to the received indication. The computing system analyzes the user profile to identify one or more biases associated with the user profile. The computing system adjusts an impact of the received indication on the initial home value estimate based on the identified one or more biases.

In some embodiments, the computing system identifies an internet protocol address from which the received indication is transmitted. The computing system identifies, from the internet protocol address, a location of the user submitted the indication. The computing system adjusts an impact of the received indication on the initial home value estimate based on the location of the user.

In some embodiments, the computing system generates an application programming interface linking functionality of the computing system to one or more third party financial institutions. The computing system provides access to the one or more third party financial institutions to one or more home value estimates.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a flow diagram illustrating a method of crowdsourcing a home value estimate, according to example embodiments.

FIG. 3 is a flow diagram illustrating a method of crowdsourcing a home value estimate, according to example embodiments.

FIG. 4 is a flow diagram illustrating a method of crowdsourcing a home value estimate, according to example embodiments.

FIG. 5 is a block diagram illustrating communication between components of the computing environment of FIG. 1, according to example embodiments.

FIG. 6A is a block diagram illustrating an exemplary graphical user interface, according to example embodiments.

FIG. 6B is a block diagram illustrating an exemplary graphical user interface, according to example embodiments.

FIG. 7 is a block diagram illustrating an exemplary graphical user interface, according to example embodiments.

FIG. 8 is a block diagram illustrating a computing environment, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

One or more techniques disclosed herein generally relate to a system and method for crowdsourcing home value estimates. Conventional methods for generating an estimate for a value of a home typically depend on purchaser-independent metrics. For example, commercial websites and home value providers typically use multiple listing services to generate an estimate on a home. While multiple listing services may provide an adequate initial baseline for a home value estimate, such services fail to take into account user preferences on particular homes.

The one or more techniques disclosed herein leverage the baselines home value estimate provided by multiple listing services or other external data sources, and crowdsource feedback on particular homes to gauge user interest in such homes. By crowdsourcing user feedback, the one or more techniques disclosed herein provide a more accurate estimate of home values. The one or more methods and systems described below generate a dynamic graphical user interface with which users may interact to provide one or more indications as to which home or which housing attribute the user prefers. Based on an aggregate of user feedback, the system is able to adjust the baseline home value estimate to generate a modified home value estimate that more accurately captures user preference.

The term “user” as used herein includes, for example, a person or entity that owns a computing device or wireless device; a person or entity that operates or utilizes a computing device; or a person or entity that is otherwise associated with a computing device or wireless device. It is contemplated that the term “user” is not intended to be limiting and may include various examples beyond those described.

The term “home” as used herein includes, for example, a house, a condominium, an apartment, a boat, a building, an apartment, and the like. It is contemplated that the term “home” be used to generally describe a physical item a user may own and/or reside.

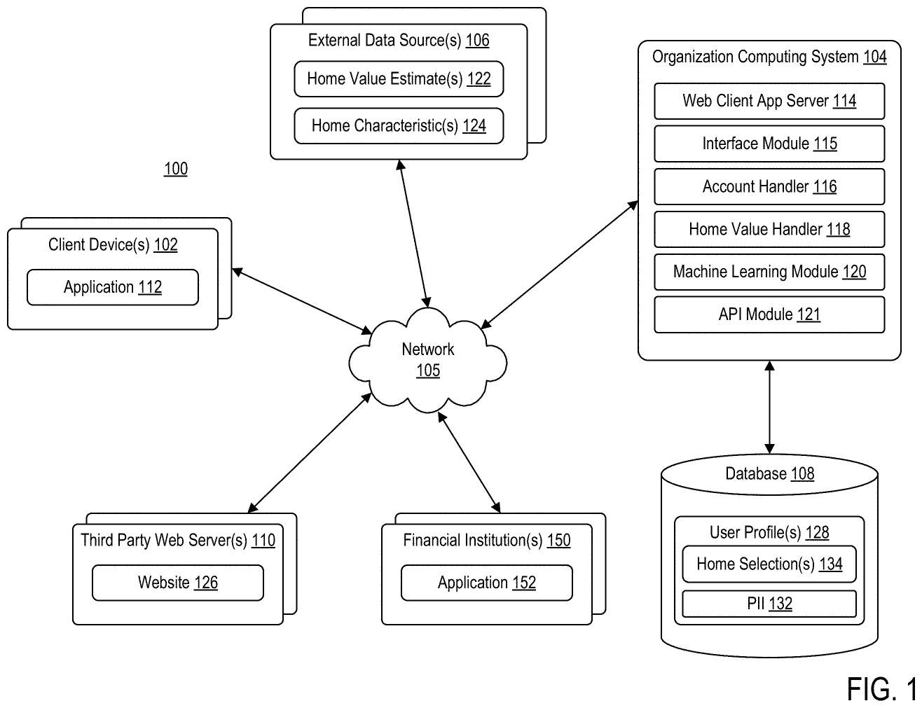

FIG. 1 is a block diagram illustrating a computing environment 100, according to one embodiment. Computing environment 100 may include at least one or more client devices 102, an organization computing system 104, one or more external data sources 106, one or more third-party web servers 110, and one or more financial institutions 150 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™ ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may include any type of computer networking arrangement used to exchange information. For example, network 105 may be the Internet, a private data network, virtual private network using a public network and/or other suitable connection(s) that enables components in computing environment 100 to send and receiving information between the components of system 100.

Client device 102 may be operated by a user. For example, client device 102 may be a mobile device, a tablet, a desktop computer, or any computing system having the capabilities described herein. Client device 102 may belong to or be provided to a user or may be borrowed, rented, or shared. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 102 may include at least application 112. Application 112 may be representative of a web browser that allows access to a website or a stand-alone application. Client device 102 may access application 112 to access the functionality of organization computing system 104. Client device 102 may communicate over network 105 to request a webpage, for example, from web client application server 114 of organization computing system 104. For example, client device 102 may be configured to execute application 112 to access content managed by web client application server 114. The content that is displayed to client device 102 may be transmitted from web client application server 114 to client device 102, and subsequently processed by application 110 for display through a graphical user interface (GUI) of client device 102.

Organization computing system 104 may include at least web client application server 114, an account handler 116, a home value handler 118, a machine learning module 120, and an API module 121. Each of account handler 116, home value handler 118, machine learning module 120, and API module 121 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components and/or be implemented in circuitry. Moreover, one or more aspects of an example algorithm may be performed by the hardware components (e.g., circuitry) itself, rather as a result of instructions.

Home value handler 118 may be configured to communicate with one or more external data sources 106. Each of the one or more external data sources 106 may correspond to one or more external computing systems storing various sets of housing information. For example, as illustrated, each of the one or more external data sources 106 may include information with respect to one or more houses including one or more home value estimates 122 and one or more home characteristics 124. The one or more home value estimates 122 may correspond to one or more computer-generated estimates and/or human generated estimates of values of homes. Such exemplary home value estimates 122 may be generated by the one or more external data sources 106. For example, one or more home value estimates 122 may correspond to home value estimates generated by one or more of Redfin, Zillow, Re/Max, Trulia, and the like. The one or more home value estimates 122 retrieved (or received) from one or more external data sources 106 may serve as a baseline, or initial, home value estimate for a corresponding home. One or more home characteristics 124 may correspond to information about particular homes. Such information may include but is not limited to, a number of bedrooms, number of bathrooms, the acreage of land, square footage, type of HVAC system, type of appliances, neighborhood crime statistics, estimated tax information, location, age of house, school district, and the like. Each house may be associated with particular characteristics that describe that house and may be used to compare and/or determine similar houses.

Machine learning module 120 may include one or more instructions to train a prediction model used by home value handler 118. To train the prediction model, machine learning module 120 may receive, as input, one or more streams of user activity. The one or more streams of user activity may correspond to actions taken by the user with respect to one or more prompts generated by organization computing system 104 seeking the input of user preference among homes. Such streams of activity may include desired number of rooms, desired number of bathrooms, desired home attributes (e.g., HVAC system, smart appliance, outdoor space, basement, attic, pool/hot tub, and the like), estimated price of the home from the user, preference between the home and other homes, and the like. In embodiments, streams of activity may be generated based on user selections of particular houses, as discussed in more detail below. For example, a user may select a particular house as being more desirable than another house. The characteristics of the selected house may be indicated as more desirable as part of training the model. In some embodiments, machine learning module 120 may further receive, as input, one or more streams of activity associated with specific trusted users that have loyalty accounts with organization computing system 104. As such, machine learning module 120 may leverage both user-specific and user agnostic information to identify user preference among various homes, which may be used to more accurately predict a value of a particular home. Machine learning module 120 may implement one or more machine learning algorithms to train the prediction model. For example, machine learning module 120 may use one or more of a decision tree learning model, association rule learning model, artificial neural network model, deep learning model, inductive logic programming model, support vector machine model, clustering model, Bayesian network model, reinforcement learning model, representational learning model, similarity and metric learning model, rule-based machine learning model, and the like.

API module 121 may include one or more instructions to execute one or more APIs that provide various functionalities related to the operations of organization computing system 104. In some embodiments, API module 121 may include an API adapter that allows API module 121 to interface with and utilize enterprise APIs maintained by organization computing system 104 and/or an associated entity that may be homed on other systems or devices. In some embodiments, APIs may enable functions that include, for example, allowing one or more financial institutions 150 to access data generated by and hosted on organization computing system 104. For example, APIs may enable financial institution 150 to retrieve housing data in calculating, for example, when an account holder has enough equity in the home to satisfy private mortgage insurance (PMI).

Account handler 116 may be configured to manage an account associated with each user. For example, account handler 116 may be configured to communicate with database 108. As illustrated, database 108 may include one or more user profiles. Each user profile 128 may correspond to a user with an account with organization computing system 104. In other words, for example, each user profile 128 may correspond to a trusted user for generating a home value estimate. Each user profile 128 may include at least one or more home selections 134 and personal identification information 132. One or more home selections 134 may correspond to one or more homes a user selected when prompted to choose among two or more homes. Such prompts may be discussed in further detail below. Personal identification information 132 may include information associated with the user. In some embodiments, personal identification information 132 may include a name, home address, billing address, mailing address, telephone number, e-mail address, social security number, and the like.

Interface module 115 may be configured to generate one or more graphical user interfaces (GUIs). For example, interface module 115 may be configured to generate one or more GUIs that prompt users to provide input that may be used for generating a home value estimate. In some embodiments, interface module 115 may generate one or more GUIs for one or more web pages hosted by web client application server 114. In some embodiments, interface module 115 may generate one or more GUIs for use with one or more websites 126 of one or more third-party web servers 110. For example, interface module 115 may be configured to generate one or more overlay windows that may be implemented with one or more websites 126. In a specific example, interface module 115 may be configured to generate one or more overlay windows that include a challenge-response test (e.g., Completely Automated Public Turing test to tell Computers and Humans Apart (CAPTCHA)) as a means to gather user feedback to generate home value estimates. Interaction with the challenge-response test may allow the user to gain access to a website 126 hosted by third-party web server 110, as well as signaling to third-party web server 110 that the user is not a computer.

Financial institutions 150 may be representative of one or more computing systems associated with one or more financial institutions. Exemplary financial institution 150 may include but are not limited to, personal banking institutions, commercial banking institutions, mortgage providers, home insurance providers, and the like. Each financial institution 150 may access functionality of organization computing system 104 via application 152. For example, organization computing system 104 may generate an API that allows financial institutions 150 to gain access to home value estimates generated by organization computing system 104 via application 152. In this way, financial institutions 150 may be able to leverage more accurate information related to the value of a particular home. Exemplary uses of this information may be, for example, an interest rate on a particular home, PMI calculation, valuation for approving a mortgage, valuation for determining the size of a home equity line of credit, challenging a government entity's assessment of a home's value, determining a price at which a seller may market their home, and the like.

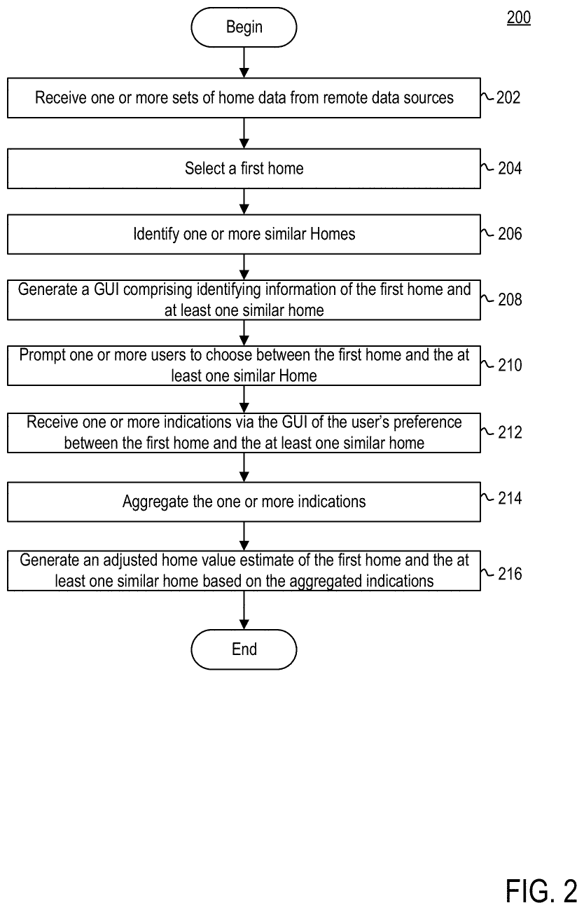

FIG. 2 is a flow diagram illustrating a method 200 of generating a home value estimate, according to example embodiments. Method 200 may begin at step 202.

At step 202, organization computing system 104 may receive one or more sets of housing data from one or more remote data sources. For example, home value handler may receive from one or more external data sources 106 one or more sets of housing data for one or more homes. For each home, the corresponding housing data may include an initial home value estimate 122 and one or more home characteristics 124. One or more home value estimates 122 may correspond to one or more computer-generated estimates generated by the one or more external data sources 106 and/or human generate estimates retrieved from the one or more external data sources 106. The one or more home value estimates 122 retrieved (or received) from one or more external data sources 106 may serve as a baseline, or initial, home value estimate for a corresponding home. One or more home characteristics 124 may correspond to information about the particular home. Such information may include but is not limited to, a number of bedrooms, number of bathrooms, the acreage of land, square footage, type of HVAC system, type of appliances, neighborhood crime statistics, estimated tax information, and the like.

At step 204, organization computing system 104 may select a first home from the one or more homes in the one or more sets of housing data. For example, home value handler 118 may identify the first home to analyze.

At step 206, organization computing system 104 may identify one or more homes that are similar to the first home. For example, organization computing system 104 may identify one or more homes within a threshold range from the initial home value estimate of the first home or a threshold range from one or more characteristics of the first home. In some embodiments, home value handler 118 may query one or more external data sources 106 with one or more identified characteristics of the first home to retrieve one or more homes that are similar to the first home. For example, home value handler 118 may query database with one or more of a number of rooms, a number of bathrooms, a location, and the like, all of which may be characteristics similar to the first home. In some embodiments, home value handler 118 may include in the query one or more pricing constraints. For example, home value handler 118 may include as a constraint in the query a pricing constraint centered about the initial home value estimate of the first home. Accordingly, home value handler 118 may query one or more external data sources 106 to identify one or more homes that are similar in characteristics and price.

At step 208, organization computing system 104 may generate a GUI to seek user input on the initial home value estimate. For example, interface module 115 may generate a GUI that includes one or more sets of identifying information for the first home and one or more sets of identifying information for at least one similar home. In some embodiments, the GUI may include one or more images of the first home and one or more images of the at least one similar home. The GUI may further include one or more prompts that seek user input as to which home the user prefers. By identifying which home (either the first home or the at least one similar home) is more “desirable” by end users, organization computing system 104 may be able to provide a more accurate home value estimate for the first home.

At step 210, organization computing system 104 may prompt one or more users to choose between the first home and the at least one similar home. For example, in some embodiments, organization computing system 104 may prompt one or more users by serving the GUI embodied in one or more web pages of a website hosted by web client application server 114. In some embodiments, organization computing system 104 may prompt one or more users to choose between the first home and the at least one similar home by transmitting the GUI to one or more third-party web servers 110. Each third-party web server 110 may serve the GUI to one or more users as an overlay window atop a web page of a website 126 hosted by third-party web server 110. In some embodiments, the overlay window may be a pop-up window. In some embodiments, the overlay window may include a challenge-response test. Interaction with the overlay window may grant the user access to website 126.

At step 212, organization computing system 104 may receive one or more indications from one or more users of a preference between the first home and the at least one similar home. For example, organization computing system 104 may receive one or more indications via input to the GUI. In some embodiments, the input may be binary (e.g., the user selects one home among the two or more homes shown to the user). In some embodiments, the input may be more nuanced. For example, the user may rank each home in the two or more homes as a means of providing input to the GUI. In another example, the user may provide a numerical value to each home of the two or more homes (e.g., 1-10 value for each home with 1 corresponding to “terrible” and 10 corresponding to “perfect”).

At step 214, organization computing system 104 may aggregate the one or more received indications from the one or more users. In some embodiments, organization computing system 104 may further normalize the one or more received indications, such that the user feedback is uniform across the aggregated indications.

At step 216, organization computing system 104 may adjust a home value estimate for the first home and the at least one similar home based on the aggregated one or more indications. For example, organization computing system 104 may provide the aggregated one or more indications, as input, to a prediction model generated by machine learning module 120. The prediction model may analyze the one or more indications and generate an output, which corresponds to an adjusted home value estimate of the first home and the at least one similar home. In some embodiments, the adjusted home value estimate may be the same as the initial home value estimate (i.e., the initial home value estimate was accurate).

Although not shown, in some embodiments, organization computing system 104 may communicate the one or more adjusted home value estimates to one or more external data sources 106.

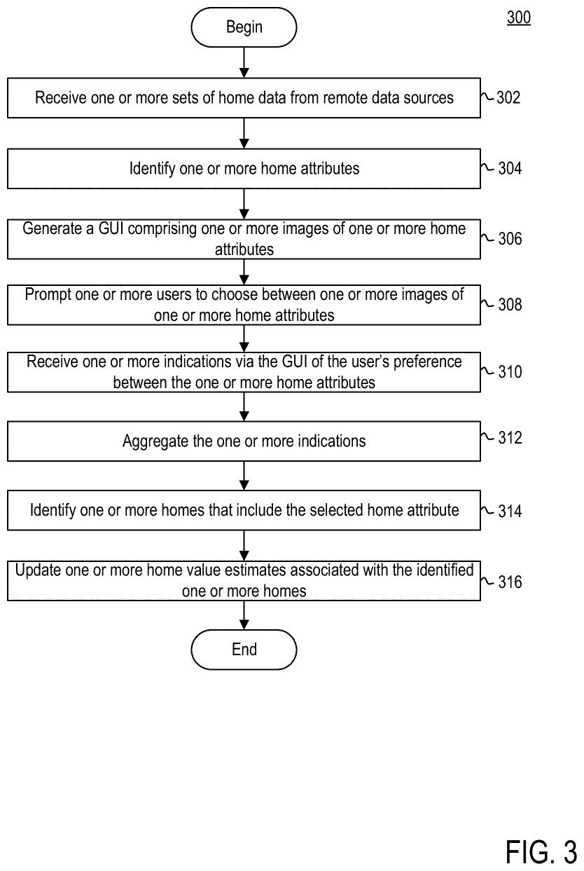

FIG. 3 is a flow diagram illustrating a method 300 of generating a home value estimate, according to example embodiments. Method 300 may begin at step 302.

At step 302, organization computing system 104 may receive one or more sets of housing data from one or more remote data sources. For example, home value handler 118 may receive from one or more external data sources 106 one or more sets of housing data for one or more homes. For each home, the corresponding housing data may include an initial home value estimate 122 and one or more home characteristics 124. One or more home value estimates 122 may correspond to one or more computer-generated estimates generated by the one or more external data sources 106. The one or more home value estimates 122 retrieved (or received) from one or more external data sources 106 may serve as a baseline, or initial, home value estimate for a corresponding home. One or more home characteristics 124 may correspond to information about the particular home. Such information may include but is not limited to, a number of bedrooms, number of bathrooms, the acreage of land, square footage, type of HVAC system, type of appliances, neighborhood crime statistics, estimated tax information, and the like.

At step 304, organization computing system 104 may identify one or more housing attributes in the one or more sets of home data. For example, home value handler 118 may analyze one or more sets of home data to identify one or more groups of housing attributes. Exemplary housing attributes may include number of rooms, number of bathrooms, type of HVAC system, square footage, and the like.

At step 306, organization computing system 104 may generate a GUI to seek user input on one or more housing attributes. For example, interface module 115 may generate a GUI that includes one or more images of one or more sets of housing attributes for a hypothetical home. In some embodiments, the GUI may include one or more prompts that seek user input as to which image the user deems more valuable. For example, the GUI may include one or more prompts seeking user input directed to which kitchen may be “nicer,” which bathrooms have higher end fixtures, which backyard area is more desirable, and the like. In another example, GUI may include map data allowing a user to select which location (e.g., cross-street) is better (e.g., more valuable, more preferable, etc.). In some embodiments, the map data may not be the exact location of the particular home; but rather, near enough to the homes that a user would be informed of the type of area in which each home is located. By identifying which attributes are deemed more “desirable” or “valuable” by end users, organization computing system 104 may be able to provide a more accurate home value estimate for homes that include such attribute and do not include such attribute.

At step 308, organization computing system 104 may prompt one or more users to choose between one or more images illustrates one or more home attributes. For example, in some embodiments, organization computing system 104 may prompt one or more users by serving the GUI embodied in one or more web pages of a website hosted by web client application server 114. In some embodiments, organization computing system 104 may prompt one or more users to choose between a home attributes by transmitting the GUI to one or more third-party web servers 110. Each third-party web server 110 may serve the GUI to one or more users as an overlay window atop a web page of a website 126 hosted by third-party web server 110. In some embodiments, the overlay window may be a pop-up window. In some embodiments, the overlay window may include a challenge-response test. Interaction with the overlay window may grant the user access to website 126.

At step 310, organization computing system 104 may receive one or more indications from one or more users of a preference between various home attributes. For example, organization computing system 104 may receive one or more indications via input to the GUI. In some embodiments, the input may be binary (e.g., the user selects one home attribute among the two or more home attributes shown to the user). In some embodiments, the input may be more nuanced. For example, the user may rank each home attribute as a means of providing input to the GUI. In another example, the user may provide a numerical value to each home attribute (e.g., 1-10 value for each home attribute with 1 corresponding to “terrible” and 10 corresponding to “perfect”).

At step 312, organization computing system 104 may aggregate the one or more received indications from the one or more users. In some embodiments, organization computing system 104 may further normalize the one or more received indications, such that the user feedback is uniform across the aggregated indications.

At operation 314, organization computing system 104 may identify one or more homes that include the selected one or more home attributes. For example, home value handler 118 may query one or more data sources 106 with the selected one or more home attributes to identify those homes that include such one or more home attributes. In some embodiments, home value handler 118 may also query one or more data sources 106 to identify one or more homes that do not include such home attributes. Each identified home may include a corresponding initial home value estimate generated by a respective external data source 106.

At step 316, organization computing system 104 may adjust an initial home value estimate for each identified home that includes the one or more home attributes. For example, organization computing system 104 may provide the aggregated one or more indications, as input, to a prediction model generated by machine learning module 120. The prediction model may analyze the one or more indications and generate an output, which corresponds to an adjusted home value estimate for each home that includes such home attributes. In some embodiments, the adjusted home value estimate may be the same as the initial home value estimate (i.e., the initial home value estimate was accurate).

Although not shown, in some embodiments, organization computing system 104 may communicate the one or more adjusted home value estimates to one or more external data sources 106.

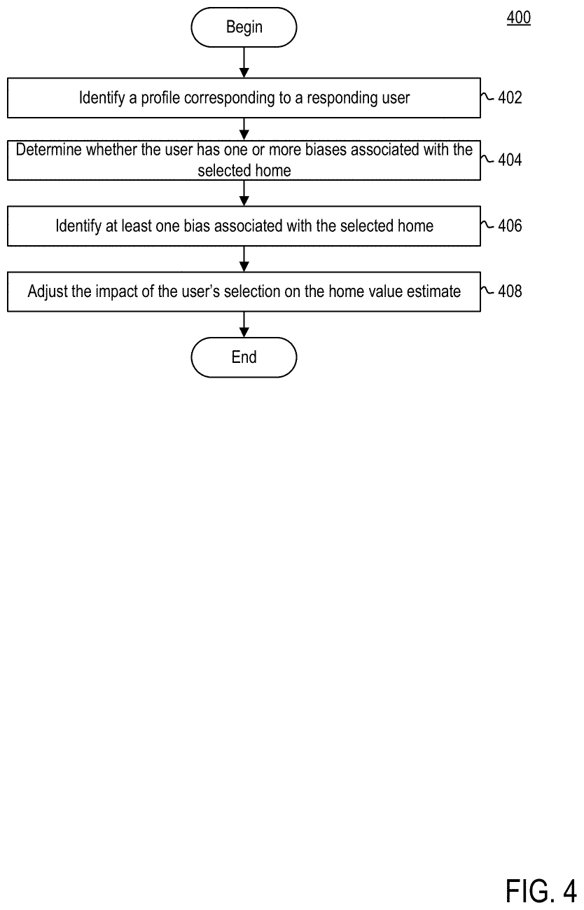

FIG. 4 is a flow diagram illustrating a method 400 of crowdsourcing a home value estimate, according to example embodiments. The one or more operations discussed in conjunction with method 400 attempt to identify one or more biases in trusted users' responses to generate a more accurate estimation of a home's value. Method 400 may begin at step 402.

At step 402, organization computing system 104 may identify a profile corresponding to a responding user. For example, account handler 116 may identify one or more user profiles 128 in database 108. Each user profile 128 may include a history of home selections 134 (and, in some embodiments, attribute selections) corresponding to a particular user. Each home selection in home selections 134 may include one or more characteristics of the home, as well as an initial home value estimate of the home.

At step 404, organization computing system 104 may determine whether that user has one or more biases towards a specific housing characteristic. For example, account handler 116 may provide one or more home selections 134, as input, to a bias prediction model generated by machine learning module 120. The bias prediction model may analyze one or more home selections 134 to determine whether the user is biased in favor of or against one or more specific housing characteristics. For example, the bias prediction model may determine that a user typically prefers homes located in a particular zip code. In another example, the bias prediction model may determine that a user typically passes on those homes that have carpeting over hardwood flooring.

At step 406, organization computing system 104 may identify at least one bias associated with the user. For example, account handler 116 may identify an output generated by the bias prediction model. The output may correspond to one or more identified biases of the user when selecting a home or housing attribute.

At step 408, organization computing system 104 may adjust the impact of user selection on home value estimates based on the identified bias. For example, home value handler 118 may adjust one or more parameters in the prediction model generated by machine learning module 120 to account for the identified user bias. In another example, home value handler 118 may adjust the impact of user feedback prior to providing user data to the prediction model.

In another example, organization computing system 104 may identify an internet protocol address (IP) from which a received response is transmitted. From the IP address, organization computing system 104 may identify a location of a user is submitting the response. The computing system may then adjust the impact of the received indication on the initial home value estimate based on the location of the user. For example, the user may be more biased towards homes proximate to the user's location. In another example, the user may be less knowledgeable about home values in a location distant from the user's location.

In some embodiments, after identifying a user's biases, organization computing system, 104 may only show that user elements that do not cross the user's one or more biases. For example, organization computing system 104 may only compare carpeted rooms to non-carpeted rooms. In another example, organization computing system 104 may only show users houses that are in a zip code associated with a user's address (e.g., home address, IP address, etc.).

Still further, in some embodiments, organization computing system 104 may seek input from users as to those elements for which the user is well informed. For example, organization computing system 104 may not prompt a user in Illinois to identify which location is better in Philadelphia.

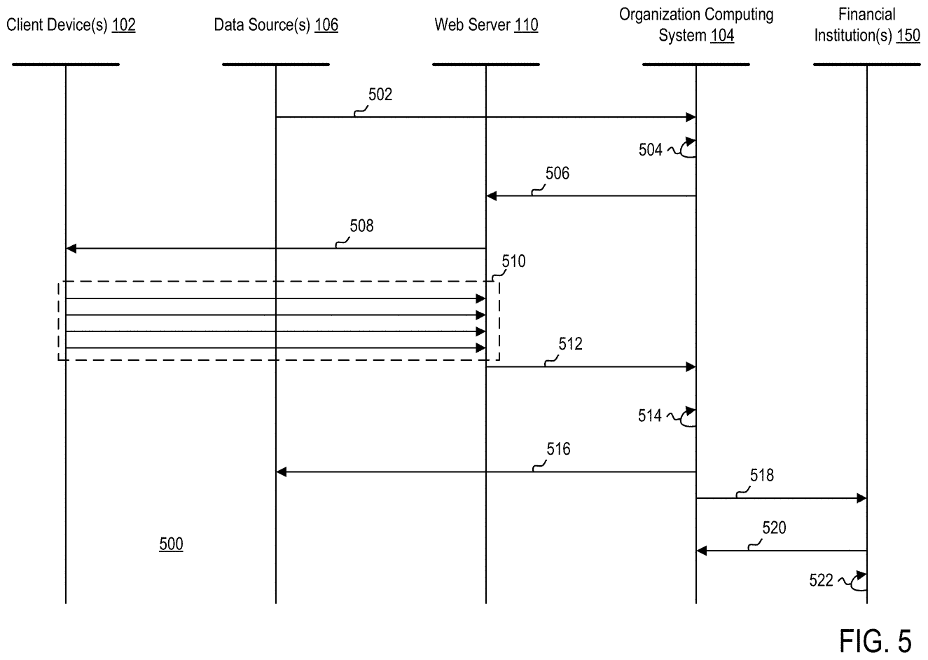

FIG. 5 is a block diagram 500 illustrating communication among components of computing environment 100, according to example embodiments.

At operation 502, one or more external data sources 106 may transmit one or more sets of housing data to organization computing system 104 for one or more homes. For each home, the corresponding housing data may include an initial home value estimate 122 and one or more home characteristics 124. One or more home value estimates 122 may correspond to one or more computer-generated estimates generated by the one or more external data sources 106. One or more home value estimates 122 retrieved (or received) from one or more external data sources 106 may serve as a baseline, or initial, home value estimate for a corresponding home. One or more home characteristics 124 may correspond to information about the particular home.

At operation 504, organization computing system 104 may receive the one or more sets of housing data from one or more external data sources 106. Organization computing system 104 may generate a GUI to seek user input on the initial home value estimate.

In some embodiments, organization computing system 104 may generate a GUI that includes one or more sets of identifying information for the first home and one or more sets of identifying information for at least one similar home. In some embodiments, the GUI may include one or more images of the first home and one or more images of the at least one similar home. The GUI may further include one or more prompts that seek user input as to which home the user prefers, which home the user thinks is more valuable, etc. By identifying which home (either the first home or the at least one similar home) is more “desirable” by end users, organization computing system 104 may be able to provide a more accurate home value estimate for the first home.

In some embodiments, organization computing system 104 may generate a GUI to seek user input on one or more housing attributes. For example, organization computing system 104 may generate a GUI that includes one or more sets of housing attributes for a hypothetical home. In some embodiments, the GUI may include one or more prompts that seek user input as to which housing attribute a user prefers. For example, the GUI may include one or more prompts seeking user input for preferences between two or more kitchens, two or more bedrooms, two or more garages, and the like. By identifying which attribute is more “desirable” across end users, organization computing system 104 may be able to provide a more accurate home value estimate for particular.

At operation 506, organization computing system 104 may transmit the generated GUI to one or more third-party web servers 110. The GUI may be transmitted to one or more third-party web servers 110 for inclusion in a website 126 hosted on a third-party web server 110. In some embodiments, the GUI may be incorporated into website 126 as an overlay window. For example, the overlay window may be a pop-up window seeking user input. In another example, the overlay window may be a challenge-response test.

At operation 508, web server 110 may render the GUI in accordance with the instructions received from organization computing system 104. Web server 110 may serve to one or more client devices 102 one or more web pages of web site 126, as well as the rendered GUI. In some embodiments, web server 110 may server the one or more web pages to one or more client devices 102 responsive to receiving a hypertext transfer protocol request from each of the one or more client devices 102.

At operation 510, the one or more client devices 102 may receive and render the one or more web pages and the GUI. One or more client devices 102 may transmit one or more indications received via the GUI to web server 110. In some embodiments, the received one or more indications from one or more client devices 102 may be representative of a preference between one or more homes. In some embodiments, the received one or more indications from one or more client devices 102 may be representative of a preference between one or more housing attributes. At operation 512, web server 110 may transmit the one or more indications to organization computing system 104.

At operation 514, organization computing system 104 may receive the one or more indications from web server 110. Organization computing system 104 may aggregate the one or more indications and provide the aggregated one or more indications to a prediction model generated by machine learning module 120. In some embodiments, the prediction model may analyze the one or more indications and generate an output, which corresponds to an adjusted home value estimate of the first home and the at least one similar home. In some embodiments, the prediction model may analyze the one or more indications and generate an output, which corresponds to an adjusted home value estimate for each home that includes such home attributes.

At operation 516, organization computing system 104 may transmit the adjusted home value estimate to one or more external data sources 106.

At operation 518, organization computing system 104 may notify one or more financial institutions 120 that an API is available to access one or more home value estimates generated by organization computing system 104. At operation 520, one or more financial institutions 120 may access the one or more home value estimates via the API. At operations 522, one or more financial institutions 150 may leverage the one or more home value estimates to generate, for example, mortgage rates, home insurance rates, PMI expiration, and the like.

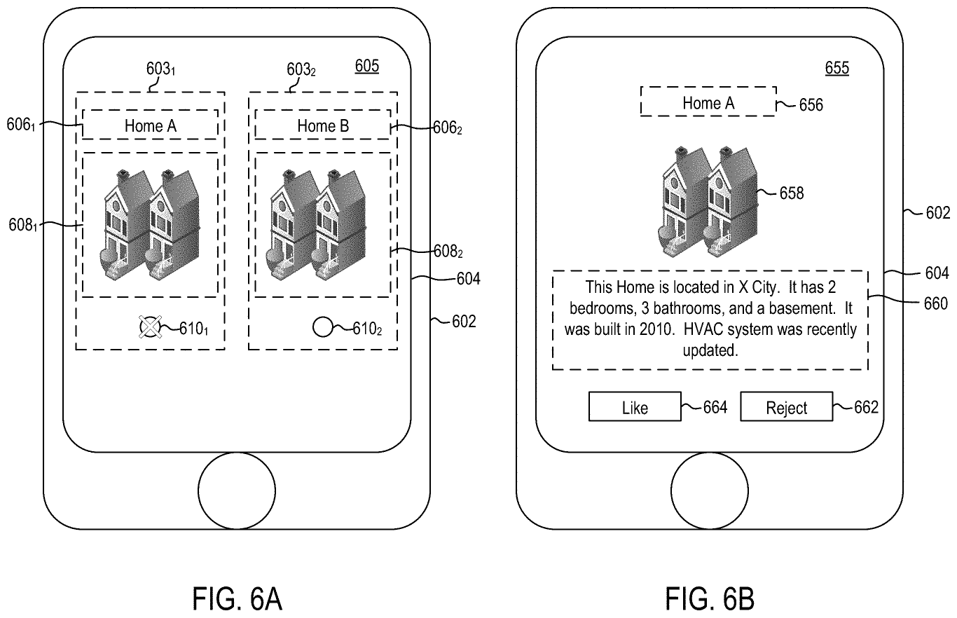

FIG. 6A is a block diagram illustrating an exemplary graphical user interface, according to example embodiments. Client device 602 may be similar to client device 102. Client device 602 may include a display 604. GUI 605 may be rendered by client device 602 and displayed via display 604 associated with client device 602. GUI 605 may be accessed via application 112 executing thereon.

GUI 605 may include one or more sets of graphical elements 603₁, 603₂ (generally “set of graphical elements 603”). Each set of graphical elements 603 may include one or more graphical elements corresponding to a particular home. For example, set of graphical elements 603₁ may correspond to “Home A,” set of graphical elements 603₂ may correspond go “Home B.”

Each set of graphical elements 603 may include a first graphical element 606, a second graphical element 608, and a third graphical element 610. Each first graphical element 606 may be representative of a name associated with a particular home. For example, first graphical element 606₁ may correspond to “Home A;” and first graphical element 606₂ may correspond got “Home B.”

Second graphical element 608 may correspond to one or more images associated with a particular home. For example, the second graphical element 608₁ may correspond to one or more images associated with Home A; and second graphical element 608₂ may correspond to one or more images associated with Home B.

Third graphical element 610 may correspond to an actionable object which may be selected by an end user of client device 602. For example, third graphical element 610 may represent a graphical object, wherein selection of the graphical object corresponds to an input associated with a preference of that particular home. As shown, third graphical element 610₁ is in a selected state; and third graphical element 610₂ is in an unselected state. Such input may correspond to an end user preferring Home A over Home B.

FIG. 6B is a block diagram illustrating an exemplary graphical user interface, according to example embodiments. Client device 602 may be similar to client device 102. Client device 602 may include a display 604. GUI 655 may be rendered by client device 602 and displayed via display 604 associated with client device 602. GUI 655 may be accessed via application 112 executing thereon.

GUI 655 may include one or more graphical elements 656-664. Graphical element 656 may correspond to a name or title associated with a particular home. For example, graphical element 656 recites “Home A.”

Graphical element 658 may correspond to one or more images associated with a particular home. For example, graphical element 658 may correspond to one or more images associated with Home A.

Graphical element 660 may correspond to a description of a particular home. In some embodiments, graphical element 660 may include one or more characteristics of the home. In some embodiments, graphical element 660 may include price and estimated taxes associated with the home. As illustrated, graphical element 660 recites “This home is located in X City. It has 2 bedrooms, 3 bathrooms, and a basement. It was built in 2010. The HVAC system was recently updated.”

Graphical element 662 and graphical element 664 may be representative of one or more selectable objects. For example, graphical element 662 may correspond to a “reject” object; graphical element 664 may correspond to a “like” object. Interaction with graphical element 662 or graphical element 664 may indicate organization computing system 104 as to whether the user likes or dislikes a particular home. The input may be provided to GUI 655 via interaction with graphical element 662 or graphical element 664. The input may then be translated and transmitted to organization computing system 104 for the process.

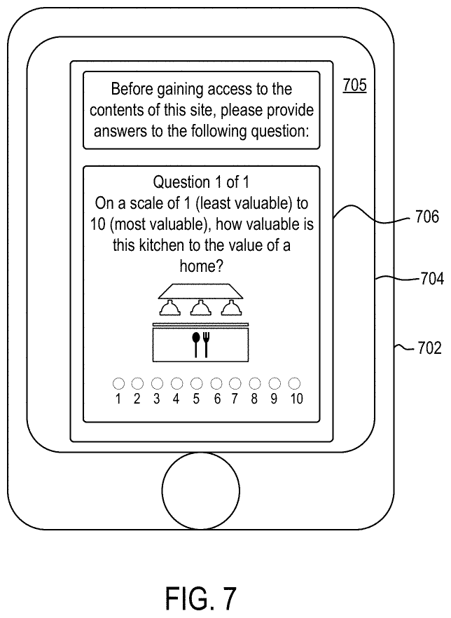

FIG. 7 is a block diagram illustrating an exemplary graphical user interface, according to example embodiments. Client device 702 may be similar to client device 102. Client device 702 may include a display 704. GUI 705 may be rendered by client device 702 and displayed via display 704 associated with client device 702. GUI 705 may be accessed via application 112 executing thereon.

GUI 705 may include graphical elements 706. Graphical element 706 may be a pop-up or overlay window positioned on top of a web page. Graphical element 706 may be a challenge-response test. As shown, the challenge response test represented by graphical element 706 may prompt users to provide input, on a scale of 1 to 10, as to how valuable the user perceives the kitchen depicted in graphical element 706. Input provided to GUI 705 via graphical element 706 may be translated and transmitted to organization computing system 104.

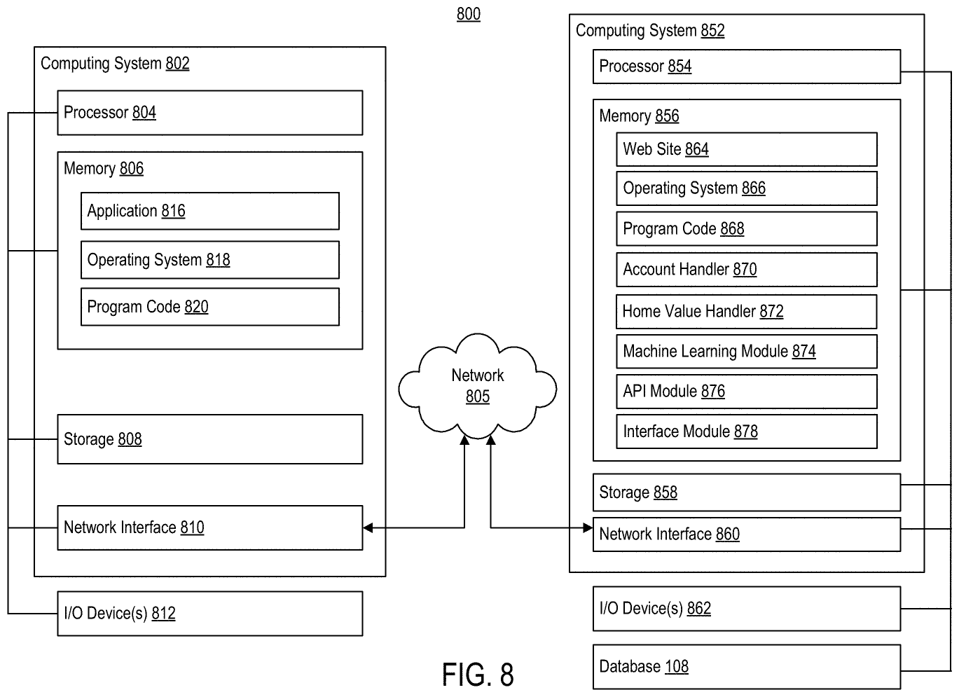

FIG. 8 is a block diagram illustrating an exemplary computing environment 800, according to some embodiments. Computing environment 800 includes computing system 802 and computing system 852. Computing system 802 may be representative of client device 102. Computing system 852 may be representative of organization computing system 104.

Computing system 802 may include a processor 804, a memory 806, a storage 808, and a network interface 810. In some embodiments, computing system 802 may be coupled to one or more I/O device(s) 812 (e.g., keyboard, mouse, etc.).

Processor 804 may retrieve and execute program code 820 (i.e., programming instructions) stored in memory 806, as well as stores and retrieves application data. Processor 804 may be included to be representative of a single processor, multiple processors, a single processor having multiple processing cores, and the like. Network interface 810 may be any type of network communications allowing computing system 802 to communicate externally via computing network 805. For example, network interface 810 is configured to enable external communication with computing system 852.

Storage 808 may be, for example, a disk storage device. Although shown as a single unit, storage 808 may be a combination of fixed and/or removable storage devices, such as fixed disk drives, removable memory cards, optical storage, network attached storage (NAS), storage area network (SAN), and the like.

Memory 806 may include application 816, operating system 818, and program code 820. Program code 820 may be accessed by processor 804 for processing (i.e., executing program instructions). Program code 820 may include, for example, executable instructions for communicating with computing system 852 to display one or more pages of website 864. Application 816 may enable a user of computing system 802 to access a functionality of computing system 852. For example, application 816 may access content managed by computing system 852, such as website 864. The content that is displayed to a user of computing system 802 may be transmitted from computing system 852 to computing system 802, and subsequently processed by application 816 for display through a graphical user interface (GUI) of computing system 802.

Computing system 852 may include a processor 854, a memory 856, a storage 858, and a network interface 860. In some embodiments, computing system 852 may be coupled to one or more I/O device(s) 862. In some embodiments, computing system 852 may be in communication with database 108.

Processor 854 may retrieve and execute program code 868 (i.e., programming instructions) stored in memory 856, as well as stores and retrieves application data. Processor 854 is included to be representative of a single processor, multiple processors, a single processor having multiple processing cores, and the like. Network interface 860 may be any type of network communications enabling computing system 852 to communicate externally via computing network 805. For example, network interface 860 allows computing system 852 to communicate with computer system 802.

Storage 858 may be, for example, a disk storage device. Although shown as a single unit, storage 858 may be a combination of fixed and/or removable storage devices, such as fixed disk drives, removable memory cards, optical storage, network attached storage (NAS), storage area network (SAN), and the like.

Memory 856 may include website 864, operating system 866, program code 868, account handler 870, home value handler 872, machine learning module 874, API module 876, and interface module 878. Program code 868 may be accessed by processor 854 for processing (i.e., executing program instructions). Program code 868 may include, for example, executable instructions configured to perform steps discussed above in conjunction with FIGS. 2-5. As an example, processor 854 may access program code 868 to perform operations generating a home value estimate. In another example, processor 854 may access program code 868 to perform operations for generating a GUI for prompting users to provide feedback. Website 864 may be accessed by computing system 802. For example, website 864 may include content accessed by computing system 802 via a web browser or application.

Home value handler 872 may be configured to communicate with one or more external data sources to obtain one or more sets of housing information. Such housing information may include one or more home value estimates and one or more home characteristics for each home. The one or more home value estimates may correspond to one or more computer-generated estimates. The one or more home characteristics may correspond to information about the particular home. Such information may include but is not limited to, a number of bedrooms, number of bathrooms, the acreage of land, square footage, type of HVAC system, type of appliances, neighborhood crime statistics, estimated tax information, and the like.

Machine learning module 874 may include one or more instructions to train a prediction model used by home value handler 872. To train the prediction model, machine learning module 874 may receive, as input, one or more streams of user activity. The one or more streams of user activity may correspond to actions taken by the user with respect one or more prompts generated by computing system 852 seeking the input of user preference among homes. Such streams of activity may include the desired number of rooms, the desired number of bathrooms, desired home attributes (e.g., HVAC system, smart appliance, outdoor space, basement, attic, pool/hot tub, and the like), estimated price of the home from the user, preference between the home and other homes, and the like. In some embodiments, machine learning module 874 may further receiver, as input, one or more streams of activity associated with specific trusted users that have loyalty accounts. As such, machine learning module 874 may leverage both user-specific and user agnostic information to identify user preference among various homes, which may be used to more accurately predict the value of a particular home. Machine learning module 874 may implement one or more machine learning algorithms to train the prediction model.

API module 876 may include one or more instructions to execute one or more APIs that provide various functionalities related to the operations of computing system 852. In some embodiments, API module 876 may include an API adapter that allows API module 876 to interface with and utilize enterprise APIs maintained by computing system 852 and/or an associated entity that may be homed on other systems or devices. In some embodiments, APIs may enable functions that include, for example, allowing one or more financial institutions to access data generated by and hosted on organization computing system 104.

Account handler 870 may be configured to manage an account associated with each user. For example, account handler 870 may be configured to communicate with database 108.

Interface module 878 may be configured to generate one or more graphical user interfaces (GUIs). For example, interface module 878 may be configured to generate one or more GUIs that prompt users to provide input that may be used for generating a home value estimate. In some embodiments, interface module 878 may generate one or more GUIs for one or more web pages of web site 864. In some embodiments, interface module 878 may generate one or more GUIs for use with one or more websites of one or more third-party web servers.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid-state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1-5. (canceled)

6. A method of crowdsourcing a home value estimate, comprising:
generating, by a computing system, a graphical user interface comprising a series of questions evaluating desired characteristics of a home;
prompting, by the computing system, users to select a desired characteristic by causing the graphical user interface to be displayed via client devices with a third party webpage;
receiving, by the computing system, a plurality of responses from the users, wherein each response is associated with a desired characteristic preference of a type of desired characteristic among the desired characteristics of the home;
aggregating, by the computing system, the plurality of responses based on the type of desired characteristic to which each response corresponds;
receiving, by the computing system from one or more external computing systems, an initial home value estimate for a first home;
identifying, by the computing system, a first characteristic associated with the first home;
identifying, by the computing system, that the first characteristic corresponds to a first type of desired characteristic;
determining, by the computing system, that the first characteristic is a highly desired characteristic preference based on the aggregated responses corresponding to the first type of desired characteristic; and
modifying, by the computing system, the initial home value estimate to a modified home value estimate based on the determining.

7. The method of claim 6, wherein the desired characteristics comprise a number of bedrooms, a number of bathrooms, square footage, neighborhood crime rate, asbestos, lead paint, types of appliances, outdoor space, parking availability, location, and type of heating, ventilation, and cooling system.

8. The method of claim 6, wherein the series of questions are represented as a series of photographs, wherein each photograph in the series of photographs corresponds to a desired characteristic.

9. The method of claim 6, wherein the series of questions are presented as part of challenge-response test.

10. The method of claim 6, further comprising:
identifying, by the computing system, a user profile corresponding to a received response;
analyzing, by the computing system, the user profile to identify one or more biases associated with the user profile; and
adjusting, by the computing system, an impact of the received response on the initial home value estimate based on the identified one or more biases.

11. The method of claim 6, further comprising:
identifying, by the computing system, an internet protocol address from which a received response is transmitted;
identifying, by the computing system from the internet protocol address, a location of a user submitting the response; and
adjusting, by the computing system, an impact of the received indication on the initial home value estimate based on the location of the user.

12. The method of claim 6, further comprising:
generating, by the computing system, an application programming interface linking functionality of the computing system to one or more third party financial institutions; and
providing access, by the computing system to the one or more third party financial institutions, to one or more home value estimates.

13-20. (canceled)

21. A system for crowdsourcing a home value estimate, comprising:
a processor; and
a memory having programming instructions stored thereon, which, when executed by the processor, performs one or more operations, comprising:
generating a graphical user interface comprising a series of questions evaluating desired characteristics of a home;
prompting users to select a desired characteristic by causing the graphical user interface to be displayed via client devices with a third party webpage;
receiving a plurality of responses from the users, wherein each response is associated with a desired characteristic preference of a type of desired characteristic among the desired characteristics of the home;
aggregating the plurality of responses based on the type of desired characteristic to which each response corresponds;
receiving, from one or more external computing systems, an initial home value estimate for a first home;
identifying a first characteristic associated with the first home;
identifying that the first characteristic corresponds to a first type of desired characteristic;
determining that the first characteristic is a highly desired characteristic preference based on the aggregated responses corresponding to the first type of desired characteristic; and
modifying the initial home value estimate to a modified home value estimate based on the determining.

22. The system of claim 21, wherein the desired characteristics comprise a number of bedrooms, a number of bathrooms, square footage, neighborhood crime rate, asbestos, lead paint, types of appliances, outdoor space, parking availability, location, and type of heating, ventilation, and cooling system.

23. The system of claim 21, wherein the series of questions are represented as a series of photographs, wherein each photograph in the series of photographs corresponds to a desired characteristic.

24. The system of claim 21, the series of questions are presented as part of a challenge-response test.

25. The system of claim 21, wherein the one or more operations further comprise:
identifying a user profile corresponding to a received response;
analyzing the user profile to identify one or more biases associated with the user profile; and
adjusting an impact of the received response on the initial home value estimate based on the identified one or more biases.

26. The system of claim 21, wherein the one or more operations further comprise:
identifying, by the computing system, an internet protocol address from which a received response is transmitted;
identifying, by the computing system from the internet protocol address, a location of a user submitting the response; and
adjusting, by the computing system, an impact of the received indication on the initial home value estimate based on the location of the user.

27. The system of claim 21, wherein the one or more operations further comprise:
generating, by the computing system, an application programming interface linking functionality of the computing system to one or more third party financial institutions; and
providing access, by the computing system to the one or more third party financial institutions, to one or more home value estimates.

28. A non-transitory computer readable medium including one or more sequences of instructions, that, when executed by one or more processors, cause the one or more processors to perform operations comprising:
generating, by a computing system, a graphical user interface comprising a series of questions evaluating desired characteristics of a home;
prompting, by the computing system, users to select a desired characteristic by causing the graphical user interface to be displayed via client devices with a third party webpage;
receiving, by the computing system, a plurality of responses from the users, wherein each response is associated with a desired characteristic preference of a type of desired characteristic among the desired characteristics of the home;
aggregating, by the computing system, the plurality of responses based on the type of desired characteristic to which each response corresponds;
receiving, by the computing system from one or more external computing systems, an initial home value estimate for a first home;
identifying, by the computing system, a first characteristic associated with the first home;
identifying, by the computing system, that the first characteristic corresponds to a first type of desired characteristic;
determining, by the computing system, that the first characteristic is a highly desired characteristic preference based on the aggregated responses corresponding to the first type of desired characteristic; and
modifying, by the computing system, the initial home value estimate to a modified home value estimate based on the determining.

29. The non-transitory computer readable medium of claim 28, wherein the desired characteristics comprise a number of bedrooms, a number of bathrooms, square footage, neighborhood crime rate, asbestos, lead paint, types of appliances, outdoor space, parking availability, location, and type of heating, ventilation, and cooling system.

30. The non-transitory computer readable medium of claim 28, wherein the series of questions are represented as a series of photographs, wherein each photograph in the series of photographs corresponds to a desired characteristic.

31. The non-transitory computer readable medium of claim 28, wherein the series of questions are presented as part of a challenge-response test.

32. The non-transitory computer readable medium of claim 28, further comprising:
identifying, by the computing system, a user profile corresponding to a received response;
analyzing, by the computing system, the user profile to identify one or more biases associated with the user profile; and
adjusting, by the computing system, an impact of the received response on the initial home value estimate based on the identified one or more biases.

33. The non-transitory computer readable medium of claim 28, further comprising:
identifying, by the computing system, an internet protocol address from which a received response is transmitted;
identifying, by the computing system from the internet protocol address, a location of a user submitting the response; and
adjusting, by the computing system, an impact of the received indication on the initial home value estimate based on the location of the user.
